(19) United States
(12) Patent Application Publication
(10) Pub. No.: US 2025/0015672 A1
(43) Pub. Date: Jan. 9, 2025

(54) MOTOR WITH INTEGRATED CONTROL AND ELECTRONIC UNIT COOLING

(71) Applicant: SAFRAN ELECTRICAL & POWER, BLAGNAC (FR)

(72) Inventors: Vincent Luc HIDELOT, MOISSY CRAMAYEL (FR); Abdoulahad THIAM, MOISSY CRAMAYEL (FR)

(21) Appl. No.: 18/697,941

(22) PCT Filed: Oct. 4, 2022
(86) PCT No.: PCT/FR2022/051876

§ 371 Date: Apr. 2, 2024

(30) Foreign Application Priority Data
Oct. 7, 2021 (FR) 2110635

(51) Int. Cl. H02K 9/06; H02K 5/20; H02K 11/33

(52) U.S. Cl. CPC H02K 9/06; H02K 5/207; H02K 11/33; H02K 2205/09

(57) ABSTRACT

A motor with integrated control, includes an electric machine equipped with a rotating portion, which is mounted on a rotary shaft; an electronic control unit for controlling the electric machine; a casing including a first cavity in which the electric machine is accommodated and a second cavity, adjacent to the first cavity, in which the electronic control unit is accommodated, the rotary shaft passing through both the first cavity and the second cavity; a thermal partition mounted at a junction between the first cavity and the second cavity; and a centrifugal pump, which is mounted on the rotary shaft at the junction between the first cavity and the second cavity of the casing and generates an airflow from the second cavity to the first cavity.

### TECHNICAL FIELD OF INVENTION

The present invention relates to a motor with integrated control—or “Smart Motor”—into which cooling of the electronic control unit is integrated.

The invention finds applications in the fields of actuators, motor drive and electrical generation, especially as applied to aeronautics. In particular, it finds applications in the field of smart motors, for example for aircraft.

### TECHNOLOGICAL BACKGROUND OF THE INVENTION

In aeronautics, as in other fields, it is becoming increasingly frequent to use motors with integrated control, or smart motors, which have the advantage of integrating both an electric machine and its electronic control unit into a same casing. The electric machine, for example a motor or generator, and the electronic control unit, for example a power electronics module, are arranged in two distinct cavities in a same casing.

FIG. 1 represents a front perspective view (drawing A), a rear perspective view (drawing B) and a transverse cross-section view (drawing C) of a smart motor 10. This smart motor 10 includes an electric machine 11 and an electronic control unit 12, both housed in a same casing 20. This casing 20 comprises two distinct cavities: a first cavity 21 in which the electric machine 11 is housed and a second cavity 22 in which the electronic control unit 12, also called the control unit, is housed.

While such smart motors have advantages, such as compactness, they also have the drawback that the control unit 12, in its conventional form, has difficulty withstanding high temperatures, that is, above 80 to 90° C. But, in operation, electric machines generate a lot of heat which tends to increase the room temperature inside the first cavity 21 to over 160° C. As the first and second cavities communicate, the ambient air in the second cavity 22 reaches temperatures well above what the components of the control unit can withstand. Thus, although electric machines are able to withstand temperatures which can reach 160° C., or even 180° C., the maximum withstood by the control unit greatly limits the applications of smart motors.

One of the known solutions for improving temperature resistance of the control unit is to offset the control unit into a so-called cool zone. This solution consists in offsetting all the electronic components forming the control unit and connecting them to the electric machine via electrical harnesses. However, such a solution is not applicable to smart motors because, since it is offset, the control unit is no longer arranged in the same casing as the electric machine.

Another solution for limiting temperature rise within the control unit is to oversize the electric machine so that it can operate at lower temperatures, for example in the order of 100 to 110° C., and not heat the control unit. This solution, which is widely used in some fields such as industry and transport, causes an increase in the mass of the smart motor, which is incompatible with aeronautical restrictions which rather require a decrease in the mass of aircraft components.

Yet another solution for improving temperature resistance of the control unit is to select so-called “high temperature” electronic components, which have the feature of withstanding high temperatures. However, this solution cannot be applied in aeronautics because this technology is new and still being developed. It is therefore particularly expensive, and most of the components are difficult or impossible to obtain. In addition, when they do exist, these so-called high temperature components often have a low level of reliability.

A final solution for improving temperature resistance of the control unit is to integrate dedicated cooling into the smart motor. This cooling, for example in the form of a fluid circuit (for example, air or liquid), is integrated into the casing to cool not only the components of the control unit but also the electric machine. This fluid cooling is often combined with thermal insulation installed between the electric machine and the control unit, for example at the junction between the first cavity accommodating the electric machine and the second cavity accommodating the control unit. This thermal insulation generally takes the form of one or more thermal partitions, referenced 30 in FIG. 1, mounted between the two cavities 21, 22 so that the control unit 12 cooled by the fluid flow does not heat up on contact with the ambient hot air in the first cavity.

In a smart motor, such as that represented in FIG. 1, the electric machine 11 integrates a rotating shaft 40 which passes right through the casing 20. Indeed, in order to reduce the forces on the bearings of the rotating shaft, it may be chosen to use a so-called “through” shaft, that is, a rotating shaft 40 which passes through not only the first cavity 21 but also the second cavity 22 and the control unit 12. It has been shown that, in such a configuration where the rotating shaft 40 passes through both cavities 21, 22, there is a real advantage in fitting a single or double thermal partition. In order to avoid friction between the rotating shaft and the thermal partition(s) (and thus avoid material being torn off, manage vibrations of the shaft, etc.), there is generally a clearance between the thermal partition(s) 30 (which are static) and the rotating shaft 40. This clearance necessarily causes hot air leaks from the first cavity 21 to the second cavity 22.

To limit the passage of hot air from the electric machine 11 to the control unit 12, it has been contemplated reducing the clearance around the rotating shaft 40 or installing baffles all around said rotating shaft 40. An example of air-retaining baffles is represented in FIG. 2 by reference 50. However, reducing the clearance and/or installing baffles does not completely prevent hot air leak from the first cavity 21 to the second cavity 22.

To limit the passage of hot air from the electric machine 11 to the control unit 12, it has also been contemplated fitting a rotary seal, also called a dynamic seal, around the rotating shaft 40. An example of such a dynamic seal is represented by reference 60 in FIG. 3. However, such a dynamic seal leads to the following consequences:
wear of the rotary seal 60 has to be taken into account through a maintenance programme of the smart motor, which is relatively restrictive;
in order to reduce wear on the seal, it is possible to reduce friction pressure. In this case, the contact pressure between the rotary seal 60 and the rotating shaft 40 is low, the seal does not slow down the rotating shaft but it will only be leak-proof with a small pressure difference between the cavities. Depending on the operating conditions, the rapid heating of the electric machine 11 leads to an overpressure in the first cavity 21 relative to the second cavity 22, generating a hot air leak towards said second cavity;
in order to increase leak-proofness, it is possible to increase the friction pressure. In this case, the contact pressure between the rotary seal 60 and the rotating shaft 40 is higher, the seal slows down the rotating shaft reducing the overall efficiency of the smart motor. In addition, as friction increases, it generates heat, which heats up the ambient air in the second cavity.

There is therefore a real need for a device for improving temperature resistance of the control unit by preventing hot air from passing from the first cavity to the second cavity while managing clearance around the rotating shaft.

### SUMMARY OF THE INVENTION

To address the above discussed problems of hot air leak through the clearance around the rotating shaft, the applicant provides a smart motor in which a centrifugal pump is mounted to the rotating shaft to generate the circulation of an air flow from the second cavity to the first cavity.

According to a first aspect, the invention relates to a smart motor comprising:
an electric machine provided with at least one turning part (also called a rotor) mounted to a rotating shaft,
an electronic control unit configured to drive the electric machine,
a casing comprising a first cavity in which the electric machine is housed and a second cavity, adjacent to the first cavity, in which the electronic control unit is housed, the first cavity and the second cavity both having the rotating shaft passing therethrough,
at least one thermal partition mounted at a junction between the first cavity and the second cavity, and a centrifugal pump mounted to the rotating shaft, at the junction between the first cavity and the second cavity of the casing, and generating the circulation of an air flow from the second cavity to the first cavity of the casing.

The circulation of an air flow from the second cavity to the first cavity makes it possible to counter the hot air leaks from the first cavity to the second cavity via the clearance around the rotating shaft. It also allows the circulation of ambient air from the second cavity into the first cavity where the ambient air is at a higher temperature, thus enabling the ambient air in the second cavity to be cooled.

Further to the characteristics just discussed in the previous paragraph, the smart motor according to one aspect of the invention may have one or more complementary characteristics from among the following, considered individually or according to any technically possible combinations:
the centrifugal pump comprises a plurality of rotary blades mounted in a ring to a cylinder integral with the rotating shaft, the rotary blades generating, when rotating, a pressure difference between the first cavity and the second cavity.
The cylinder of the centrifugal pump includes, at one end, a shoulder providing bypass of the air flow away from the rotating shaft.
The shoulder is substantially parallel to this thermal partition so that said thermal partition channels the air flow.
The blades each comprise a bent shape with a convex surface integral with the cylinder.
The blades are inclined or cambered, with a shape adapted to the need for air circulation, each blade comprising a side surface askew (bias) relative to a plane perpendicular to a plane tangential to the cylinder of the centrifugal pump.
The blades are planar, each blade comprising a side surface contained in a plane perpendicular to a plane tangential to the cylinder of the centrifugal pump.
The casing includes drain ports ensuring circulation of the air flow within said casing.
At least one drain port is located in a first outer wall of the second cavity and at least one drain port is located in a circular shell of the casing, at the periphery of the first cavity.

### BRIEF DESCRIPTION OF THE FIGURES

Other advantages and characteristics of the invention will become apparent upon reading the following description, illustrated by the figures in which:

FIG. 1, already described, represents a front perspective view (drawing A), a rear perspective view (drawing B) and a transverse cross-section view (drawing C) of a smart motor according to the state of the art;

FIG. 2, already described, represents a transverse cross-section view of a smart motor equipped with a device according to the state of the art for preventing the hot air leaks via the clearance around the rotating shaft;

FIG. 3, already described, represents a transverse cross-section view of a smart motor equipped with another device according to the state of the art for preventing the hot air leaks via the clearance around the rotating shaft;

FIG. 4 represents a schematic perspective view of an example of centrifugal pump according to the invention mounted to a rotating shaft of a smart motor;

FIG. 5 represents a partial schematic cross-section view of the centrifugal pump of FIG. 4 mounted at the junction of the first cavity and the second cavity;

FIG. 6 represents a schematic transverse cross-section view of a smart motor equipped with the centrifugal pump of FIG. 4;

FIG. 7 represents the views of the centrifugal pump of FIGS. 4 and 5, in which the circulation of the air flow generated by the centrifugal pump is depicted;

FIG. 8 schematically represents a side view of an example of blade of the centrifugal pump of FIG. 4; and

FIG. 9 represents a partial transverse cross-section view of a smart motor according to an embodiment of the invention.

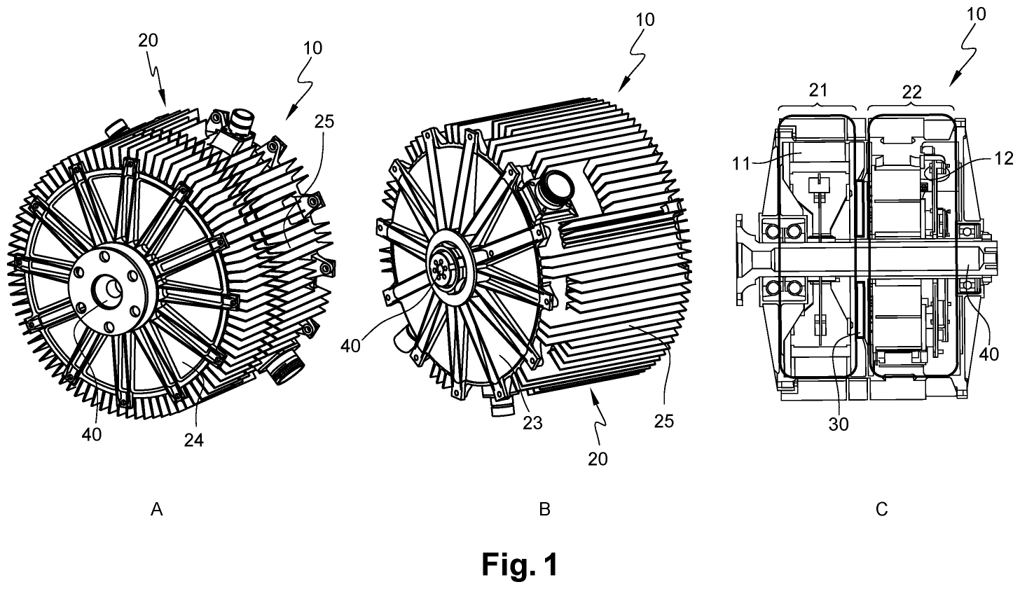

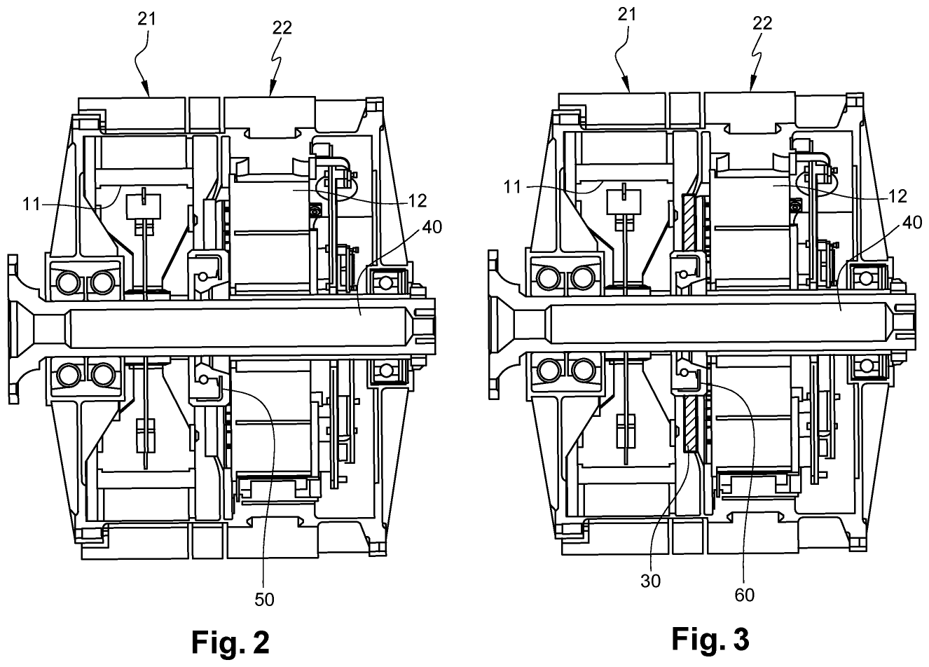

### DETAILED DESCRIPTION

An example of embodiment of a smart motor equipped with a centrifugal pump according to the invention, generating the circulation of an air flow from the cavity accommodating the control unit to the cavity accommodating the electric machine, is described in detail below, with reference to the appended drawings. This example illustrates the characteristics and advantages of the invention. It is reminded, however, that the invention is not limited to this example.

In the figures, identical elements are marked by identical references. For reasons of legibility of the figures, the size scales between the elements represented are not respected.

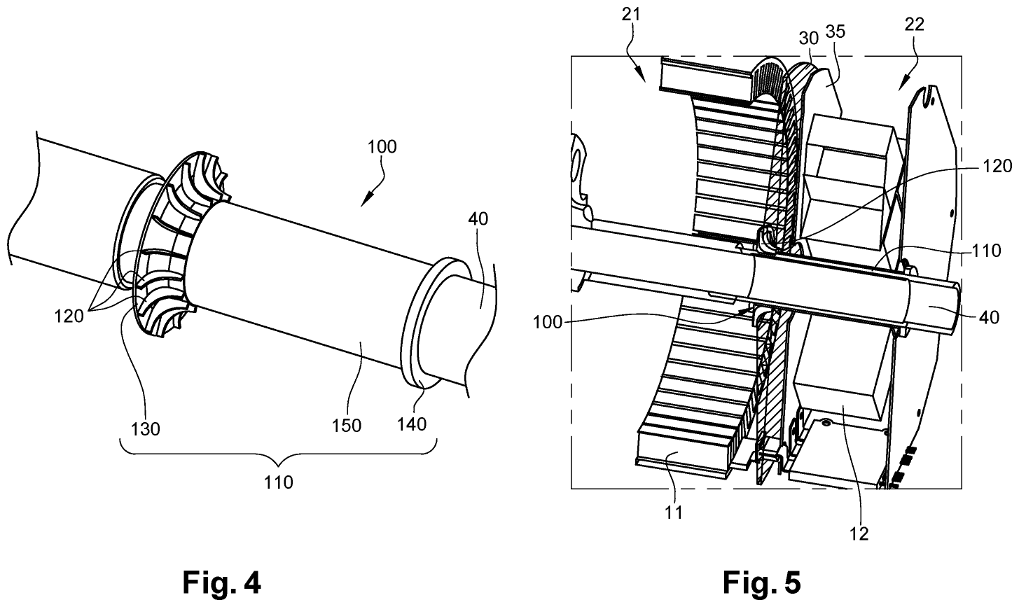

An example of a centrifugal pump 100 according to the invention is represented in FIGS. 4, 5 and 9. This centrifugal pump 100 is a pump or compressor which sucks up air from the first cavity 21 to send it into the second cavity 22 under the effect of centrifugal force. The centrifugal pump 100 is mounted around the rotating shaft 40 of the smart motor 10 in order to reduce the temperature of the control unit 12 by preventing hot air from passing, through the clearance around the rotating shaft 40, from the first cavity 21 to the second cavity 22. For this, the centrifugal pump 100 is mounted at the junction between the first cavity 21, which accommodates the electric machine 11, and the second cavity 22, which accommodates the control unit 12. The zone in the casing that extends around the rotating shaft on either side of the thermal partition, at the boundary between the first cavity and the second cavity, is referred to as the “junction”.

As explained in the state of the art, a smart motor may comprise one or more thermal partitions 30 separating the first cavity 21 and the second cavity 22. The smart motor according to the invention may also, depending on the embodiment, include one or more thermal partitions 30. In the remainder of the description, reference will be made indiscriminately to the thermal partition or partitions, it being understood that the positioning and operation of the centrifugal pump 100 is identical regardless of the number of thermal partitions.

The function of the centrifugal pump 100 is to suck up air from the second cavity 22 and to circulate the air flow sucked up through the clearance between the shaft 40 and the thermal partition 30 in the direction of the first cavity 21. The ambient air of the second cavity 22 (that is, the air in the vicinity of the control unit 12) is thus expelled towards the first cavity 21 so that, not only are potential air leaks in the clearance between the thermal partition and the shaft neutralised, but also the heated air of the second cavity 22 is sent towards the first cavity 21 (where even hotter air prevails), which cools the ambient air of the second cavity.

Unlike a fan, which generates an air velocity, the centrifugal pump 100 is indeed designed to generate a pressure difference. In particular, in the invention, the centrifugal pump 100 generates a pressure difference between the two cavities 21, 22 to prevent hot air from the first cavity from entering the second cavity. In other words, the centrifugal pump 100 of the invention, with its specific blades as described later, ensures extraction of the air from the second cavity (or cold cavity) to release it into the first cavity (or hot cavity).

According to some embodiments represented in FIGS. 4 to 6, the centrifugal pump 100 includes a cylinder 110 and rotary blades 120 distributed around the circumference of said cylinder 110 to form a bladed impeller. The cylinder 110 is mounted around the rotating shaft 40 (more simply called the shaft) and driven by the latter. When the engine is operating, the cylinder 110, and consequently the rotary blades 120, are thus rotated by the shaft 40. The cylinder 110 can, for example, be force-mounted around the shaft 40 or attached by any attachment means known in the field of motors and drivetrain such as, for example, by screwed assembly, key, spline, pin, elastic pin or other . . . . The cylinder 110 may extend over a shorter or longer portion of the shaft 40 and may, for example, pass through the control unit 12 or the electric machine 11. In the example in FIGS. 4 and 5, the cylinder 110 extends from the zone close to the thermal partition 30 of the first cavity 21 to the rear first outer wall 23 of the casing 20. In this example, the cylinder 110 is axially blocked on the shaft 40 by means of a first shoulder 130 and a second shoulder 140 directly or indirectly in abutment on elements of the rotor, such as the impeller 11 and the rear bearing. Alternatively, the cylinder could be axially blocked by (direct or indirect) abutment on either side of the thermal partition 30 or by (direct or indirect) abutment on other elements of the rotor.

The rotary blades 120, more simply called the blades, are mounted to the cylinder 110 so as to be integral with said cylinder. They can, for example, be made as a single piece with the cylinder 110 or be attached to the cylinder by any attachment means known in the field of motors and drivetrain, such as welding, bonding, screwing, riveting or other . . . . The rotary blades 120 are evenly distributed around the contour of the cylinder 110 and form a ring of blades. When these blades, driven by the cylinder 110, rotate, they impart a rotational movement to the volume of air located between each pair of blades. Under the effect of the rotation of the blades 120, the air flow between each pair of blades undergoes a centrifugal force and tends to move radially towards the outside of the cavities. The vacuum created by the discharge of this volume of air will have the effect of sucking up the air between each pair of blades, thus generating a pressure difference and hence an air flow.

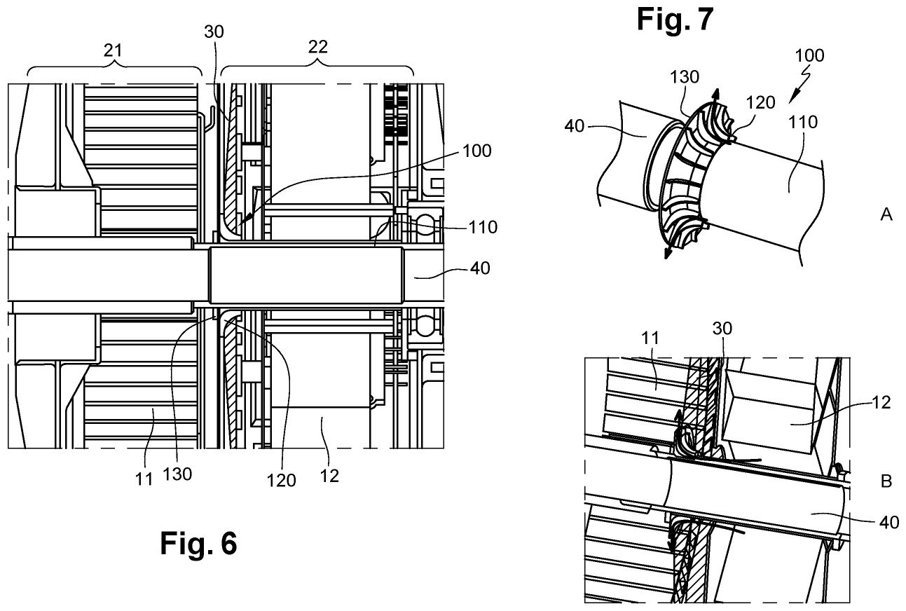

According to some embodiments, the rotary blades 120 are located radially between the thermal partition(s) 30 and the cylinder 110. In other words, the blades 120 are positioned at least partially in a clearance between the thermal partition 30 and the shaft 40, at the junction between the first cavity 21 and the second cavity 22. In the example in FIG. 5, two thermal partitions 30 and 35 are represented, the thermal partition 30 closing the first cavity 21 and the thermal partition 35 closing the second cavity 22. In the example in FIG. 6, a single thermal partition 30 is represented which ensures separation between the first and second cavities. Regardless of the number of thermal partitions, the rotation of the blades 120 causes a pressure difference between the first cavity and the second cavity, this pressure difference ensuring the air flow from the second cavity 22 to the first cavity 21.

As represented in FIGS. 4 and 7, the cylinder 110 of the centrifugal pump 100 may include a cylindrical wall 150 which terminates, at a first end, in a shoulder 130 (also called the first radial end) projecting with respect to the cylinder 110 and/or the blades 120. This shoulder 130 forms bypass for the air flow generated by the rotation of the blades. This bypass has the effect of expelling the air flow away from the rotating shaft 40, for example towards the outside of the first cavity, thus creating a lack of air between the blades, which causes suction along the cylindrical wall 150 of the cylinder.

The shoulder 130 may extend substantially in parallel to the thermal partition 30. The shoulder 130 and the thermal partition 30 thus form together a flow channel for the air flow, the thermal partition 30 acting as a fairing channelling the air flow. In other words, the air in the vicinity of the cylindrical wall 150, in the second cavity 22, is sucked up and entrained by the shoulder 130 into the first cavity 21, along the thermal partition 30. Thus as long as the blades 120 are rotating, a pressure difference is ensured between the first and second cavities, forcing the air flow to circulate from the second cavity 22 to the first cavity 21.

The rotary blades 120, whose role has been explained previously, are integral with the cylinder 110, preferably in the vicinity of the intersection between the shoulder 130 and the cylindrical wall 150. The blades 120 can then be attached to both the cylindrical wall and the shoulder. Alternatively, the blades 120 and the shoulder 130 form together an assembly integral with the cylindrical wall 150.

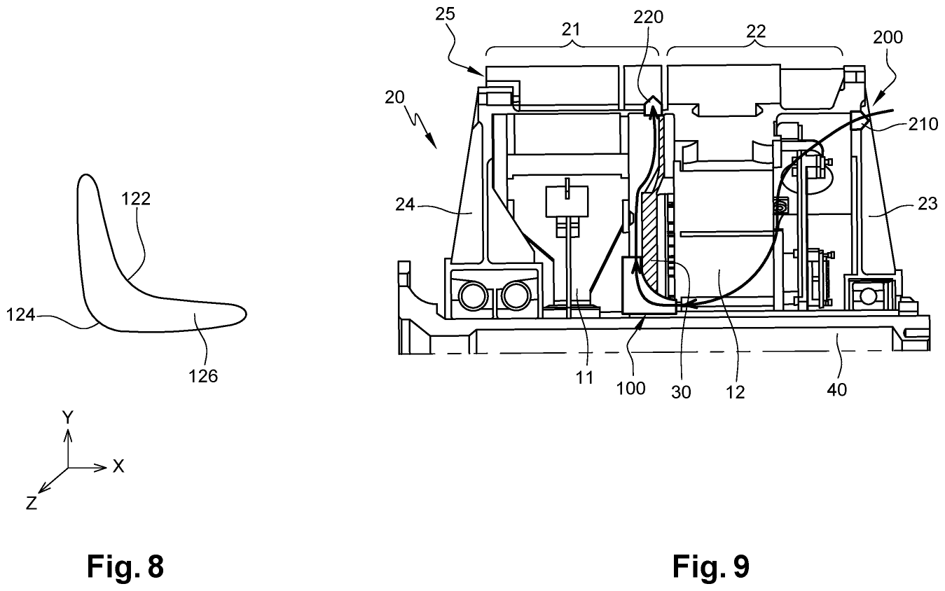

Whatever their method of manufacture, the blades 120, one example of which is represented in FIG. 8, may each have a bent shape with a convex surface 124, a concave surface 122 and two side surfaces 126. In this example of blade, the convex surface 124 is the part of the blade integral with the cylinder 110 (cylindrical wall 150 and shoulder 130), the concave surface 122 and the side surfaces 126 are the parts of the blade in contact with the air flow. The blades 120 may be planar, as in the example in FIGS. 4 and 7; the side surfaces 126 of the blades are then contained in a radial plane, perpendicular to a plane tangential to the cylinder 110. Referring to the reference frame XYZ represented in FIG. 8, a blade is planar when its side surfaces 120 are contained entirely in the plane XY. Such planar blades have the advantage of allowing an operation of the centrifugal pump 100 in both directions of rotation of the shaft 40. According to an alternative, the blades 120 may be inclined or cambered, that is, their side surfaces 126 are no longer in the plane XY, perpendicular to a plane tangential to the cylinder 110. Referring to the reference frame XYZ in FIG. 8, a blade is inclined or cambered when its convex surface 124 is in the plane XY but its concave surface 122 and its side surfaces 126 are inclined with respect to this same plane XY. For aerodynamic or aeraulic reasons, the inclination or camber of the blades 120 is preferably curved, not angular, so as to optimise the circulation of the air flow. Such inclined or cambered blades enable the geometry of the blades and of the centrifugal pump to be optimised as a function of the desired air flow (depending especially on the speed of rotation of the shaft and the characteristics of the air), when the centrifugal pump is operating in a defined direction of rotation.

In some designs, the casing 20 is provided with ports which may serve for draining ensuring optimum circulation of the air flow within said casing. Examples of such drain ports 200 are represented in FIG. 9. These drain ports 200 may enable on the one hand possible condensates to be discharged out of the casing, and on the other hand an air flow passing through at least one of the cavities 21 and 22 to be created so as to ensure cooling of the components of the control unit 12 and/or the electric machine.

In the example in FIG. 9, the casing 20 includes a circular shell 25 forming the protective housing for the cavities 21 and 22. It also includes a rear first outer wall 23 closing the cavity 22 of the control unit 12 and a front second outer wall 24 closing the cavity 21 of the electric machine 11. As explained previously, the casing 20 further includes at least one thermal partition 30 separating the cavities 21 and 22. In the example in FIG. 9, the drain ports 200 are located on the one hand in the rear first outer wall 23 and on the other hand in the circular shell 25, at the periphery of the first cavity 21. For example, one or more first drain ports 210 can be positioned in the first outer wall 23 of the casing, in proximity to the circular shell 25, and one or more second drain ports 220 can be positioned in the circular shell 25, at the periphery of the first cavity 21, in proximity to the thermal partition 30. The circulation of the air flow created by these drain ports 210 and 220 is represented in FIG. 9 by arrows. In this example of FIG. 9, it can be seen that the air flow passes through the entire second cavity 22 so that, in addition to circulating the air flow from the second cavity 22 to the first cavity 21, it also cools some of the components of the control unit 12.

Of course, other locations of the drain ports 200 may offer other advantages such as, for example, also cooling the electric machine 11. The position and number of the drain ports 210 and 220 are defined as a function of the zones to be cooled and the desired draining. For example, the drain ports may be spaced apart and reduced in number to cause a predefined circulation of the air flow or, on the contrary, relatively numerous and distributed in a predefined zone (for example over the entire external diameter of an outer wall 23, 24 or the entire circumference of the circular shell 25) to cause an overall air flow inside one or both cavities 21, 22.

Although described through a number of examples, alternatives and embodiments, the smart motor according to the invention comprises various alternatives, modifications and improvements which will be obvious to the person skilled in the art, it being understood that these alternatives, modifications and improvements are within the scope of the invention.

1. A smart motor comprising:
an electric machine having at least one turning part mounted to a rotating shaft,
an electronic control unit configured to drive the electric machine,
a casing comprising a first cavity in which the electric machine is housed and a second cavity, adjacent to the first cavity, in which the electronic control unit is housed, the first and second cavities both having the rotating shaft passing therethrough,
at least one thermal partition mounted at a junction between the first cavity and the second cavity,
a centrifugal pump mounted to the rotating shaft, at the junction between the first cavity and the second cavity of the casing, and configured to generate circulation of an air flow from the second cavity to the first cavity of the casing.

2. The smart motor according to claim 1, wherein the centrifugal pump comprises a plurality of rotary blades mounted in a ring to a cylinder integral with the rotating shaft, the rotary blades generating, when rotating, a pressure difference between the first cavity and the second cavity.

3. The smart motor according to claim 2, wherein the cylinder of the centrifugal pump includes, at one end, a shoulder providing bypass of the centrifugal air flow.

4. The smart motor according to claim 3, wherein the shoulder is substantially parallel to the thermal partition so that said thermal partition channels the air flow.

5. The smart motor according to claim 2, wherein the rotary blades each comprise a bent shape with a convex surface integral with the cylinder.

6. The smart motor according to claim 2, wherein the rotary blades are inclined or cambered, with a shape adapted to the need for air circulation, each rotary blade comprising a side surface askew relative to a plane perpendicular to a plane tangential to the cylinder of the centrifugal pump.

7. The smart motor according to claim 2, wherein the rotary blades are planar, each rotary blade comprising a side surface contained in a plane perpendicular to a plane tangential to the cylinder of the centrifugal pump.

8. The smart motor according to claim 1, wherein the casing includes drain ports ensuring circulation of the air flow within said casing.

9. The smart motor according to claim 8, wherein at least one drain port is located in a first outer wall of the second cavity and at least one drain port is located in a circular shell of the casing, at the a periphery of the first cavity.
